(19) United States
(12) Patent Application Publication
(10) Pub. No.: US 2008/0000359 A1
(43) Pub. Date: Jan. 3, 2008

(54) SINGLE-SERVING DEVICE FOR THE DISPLAY AND COOKING OF IN PARTICULAR KERNELS OF CORN FOR MAKING POPCORN

(76) Inventor: Francois Berthault, Saint Genis De Saintonge (FR)

Correspondence Address: YOUNG & THOMPSON, 745 SOUTH 23RD STREET, 2ND FLOOR, ARLINGTON, VA, 22202, US

(21) Appl. No.: 11/773,598

(22) Filed: Jul. 5, 2007

Related U.S. Application Data
(63) Continuation-in-part of application No. 10/530,891, filed on Apr. 11, 2005.

(30) Foreign Application Priority Data
Oct. 9, 2002 (FR) 02 12546

(51) Int. Cl. A47J 27/00

(52) U.S. Cl. 99/323.5

(57) ABSTRACT

The object of the invention is a device for packaging and cooking that is suitable for popcorn and that comprises a first container into which is placed a small container (62) of limited volume, characterized in that the small container (62) is produced from a mold that comprises a first portion that forms a container and at least a second portion that forms a pivoting cover that is connected to the first portion on the one hand, by at least one folding line that forms a joint, and, on the other hand, by a thermosetting bond so as to form a sealed chamber in a first state called a closed state and to allow the pivoting of the cover so as to allow the expansion of popcorn into a second state called an open state, after the thermosetting bond is broken when the temperature exceeds a certain threshold.

This invention relates to a single-serving device for the display and cooking of in particular kernels of corn for making popcorn.

This invention is described with regard to a well-known product, popcorn, but it is possible to consider other applications, in particular appetizers such as snacks of any kind, balls, fried or made from corn semolina converted into semolina and compressed and prepared in a suitable way.

For reasons of simplifying the explanation and taking into account the fact that the device is in all cases used in a totally identical way, the description is given for the natural corn kernel and the production of popcorn.

It has been known for a long time that corn kernels, when heated, burst by forming a white corolla, whereby the product is referred to as popcorn.

These kernels of corn should be placed in a container in the presence of grease.

With the invention of the microwave oven, however, the manufacturers proposed corn kernels packaged in bags with grease immobilizing the corn kernels under cold conditions because the grease congeals.

Actually, to ensure an efficient popping that is as complete as possible, it was preferable that the corn kernels remain pressed against one another. Radiation was then concentrated, and efficiency was increased.

The corn kernels themselves are different only in that they are used with thermal heating or with microwave heating. There is no need for a special prior treatment. The water that is contained in the kernels that is converted into vapor causes the explosion of the kernel shell and the formation of popcorn.

In the case of these flexible packages, the bag is made of a material that is suitable for letting microwaves pass through without being degraded under their effects, and this bag is also used as a container. More precisely, the complex comprises at least one microwave-reactive layer that transmits a portion of the microwaves., absorbs another portion of them for conversion into infrared radiation and in contrast reflects the infrared thus produced to reconstitute the heating conditions that are adequate for causing the kernels to pop.

In contrast, after cooking, the bag remains very hot because of the very small thickness of the package and the heat that is generated.

Once the kernels have popped, in the case of sweetened popcorn if it is desired to convert the sugars and obtain the organoleptic properties produced by the Maillard reactions that provide the taste of caramel from sugar, it is necessary to reach an adequate temperature, which makes such a package difficult to create.

More particularly, a product of this type is known under the name Crousti Pack.

For the consumer, it takes only placing the package in the microwave oven, putting the latter into operation for the recommended period, and taking out the container with its popcorn ready to be eaten.

It is the swelling of the popcorn and the generation of steam with the expansion of the contained air that ensure the swelling and the unfolding of the bag that initially contains the corn kernels.

Since then, it is known that microwave ovens have been improved and that the radiation is homogeneous and that it is no longer necessary to pack the kernels against one another.

In contrast, there exists a problem that relates to the display because once unfolded, the bag that is made of a complex of plastic and/or paper films does not have any stability and it cannot be used as a display container. As indicated above, the bag remains extremely hot after the popcorn is produced.

In contrast, it is also understood that the initial package should of necessity be folded to reduce its volume. The kernels could move in a container that was much too large before cooking, which is not desirable and, moreover, it is not possible to transport packages that are 9/10 empty. It is necessary that they be folded.

A foldable box for cooking popcorn is described in the document U.S. Pat. No. 5,468,938. This parallelepipedic box comprises lateral walls with automatic assembly flaps. In flat position, the rear and front faces are flattened against the bottom and top faces. To form the box, it takes only pushing the opposing edges toward one another. The corn kernels are packaged in a bag that can be introduced into the box.

This solution is not satisfactory because the bag is not immobilized in the folded box and prevents a complete folding of the box.

Also, this invention proposes a new device that makes it possible to use and to preserve corn kernels, to carry out the popping of these kernels in a microwave oven and to display the popcorn that is produced.

According to one objective, the invention proposes a device that makes possible risk-free usage and that increases the expiration date for consumption.

This invention is described in detail with regard to the accompanying drawings that show a preferred but nonlimiting embodiment, whereby the figures correspond to

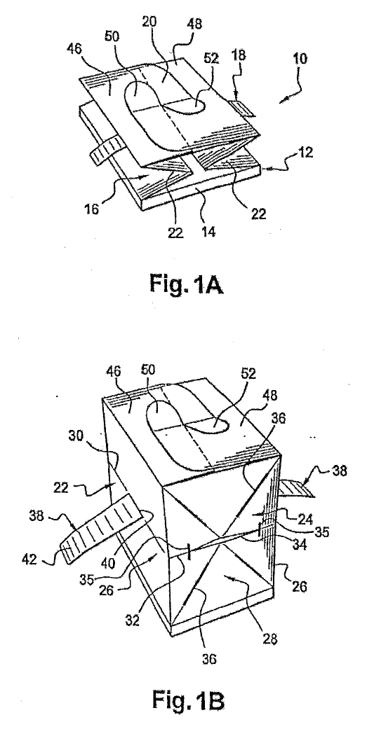

FIG. 1A, a view of the device for the display and cooking of kernels of corn according to this invention, in the folded position.

FIG. 1B, a view of this same device after unfolding, ready for cooking,

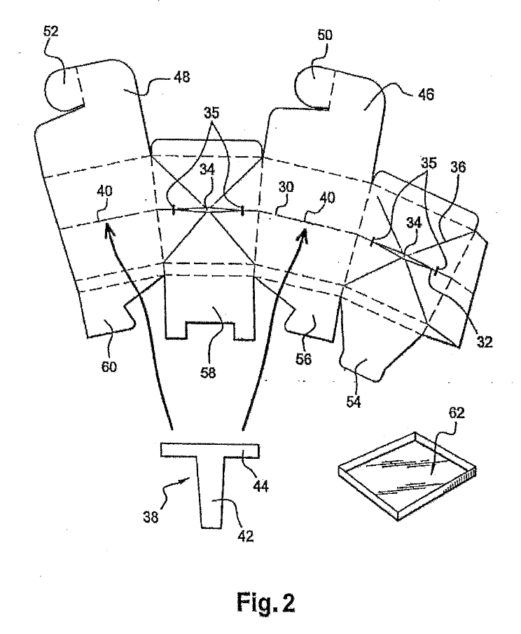

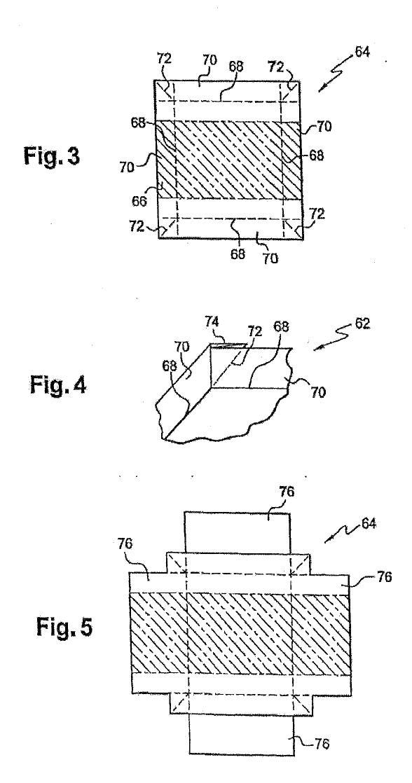

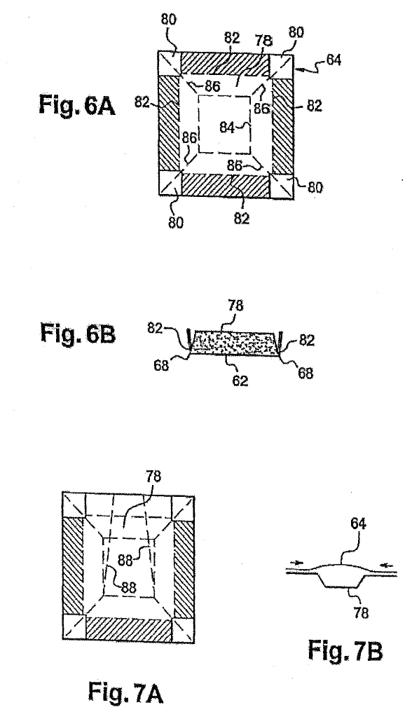

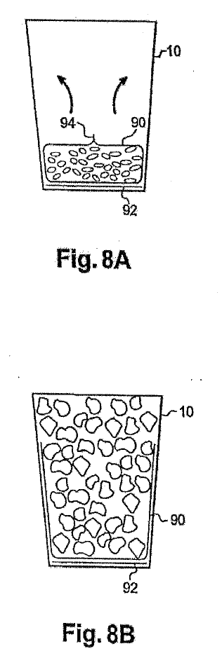

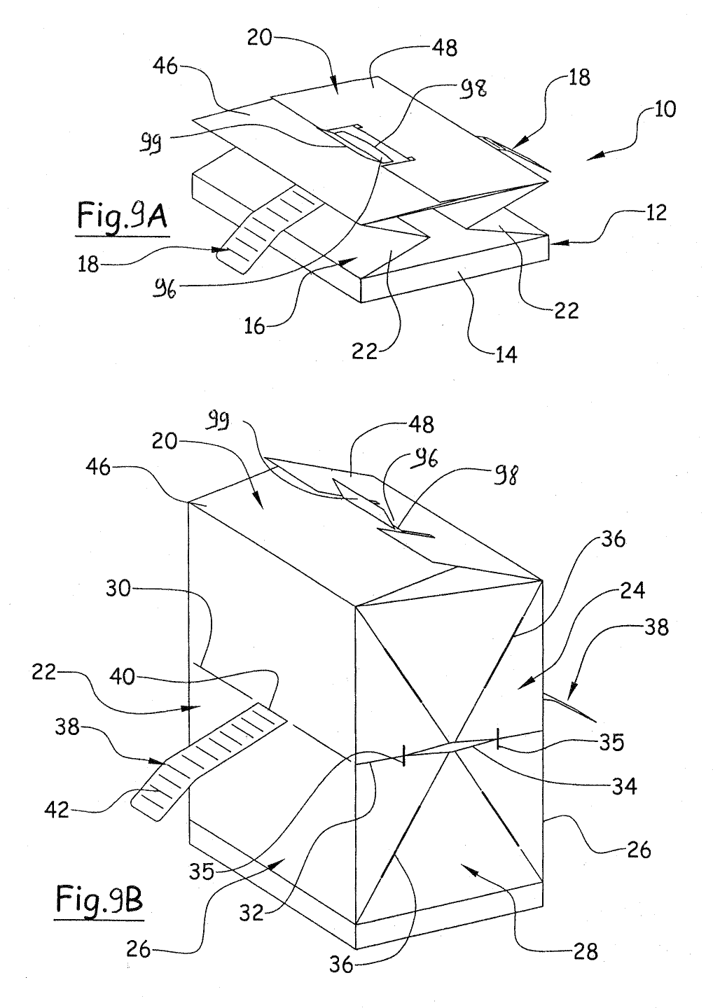

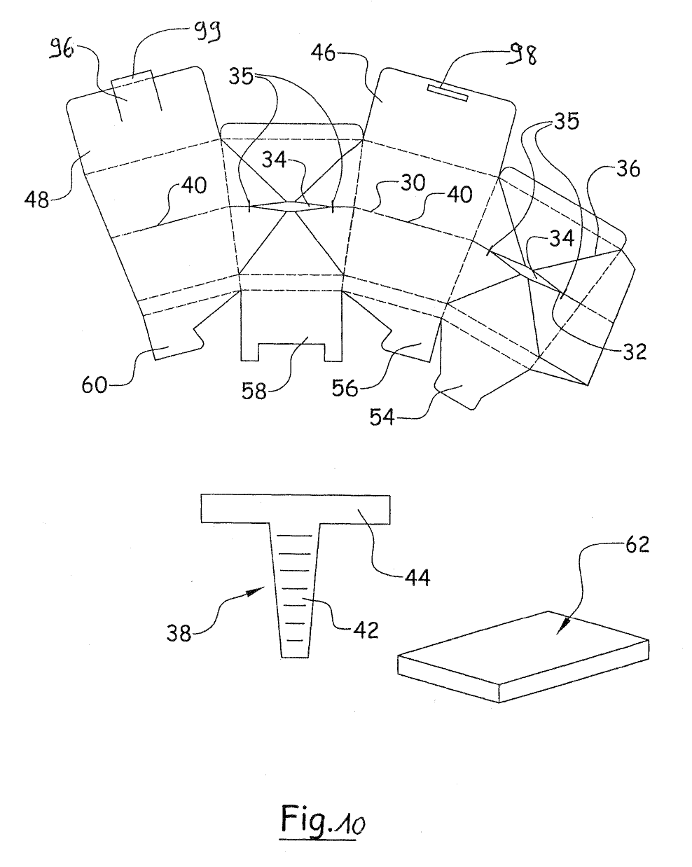

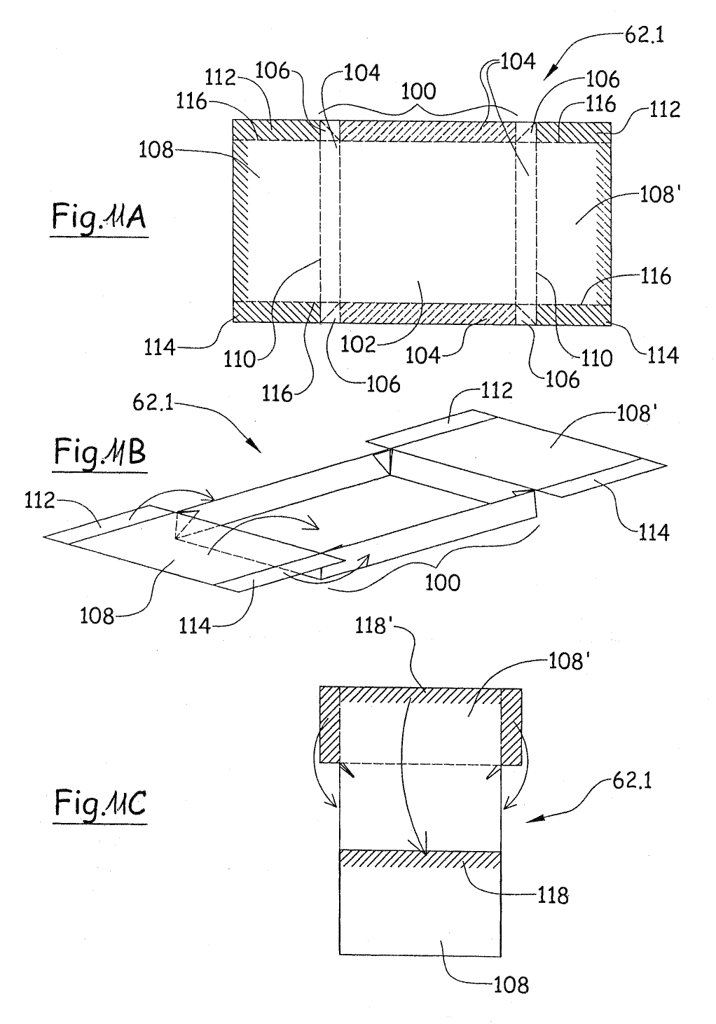

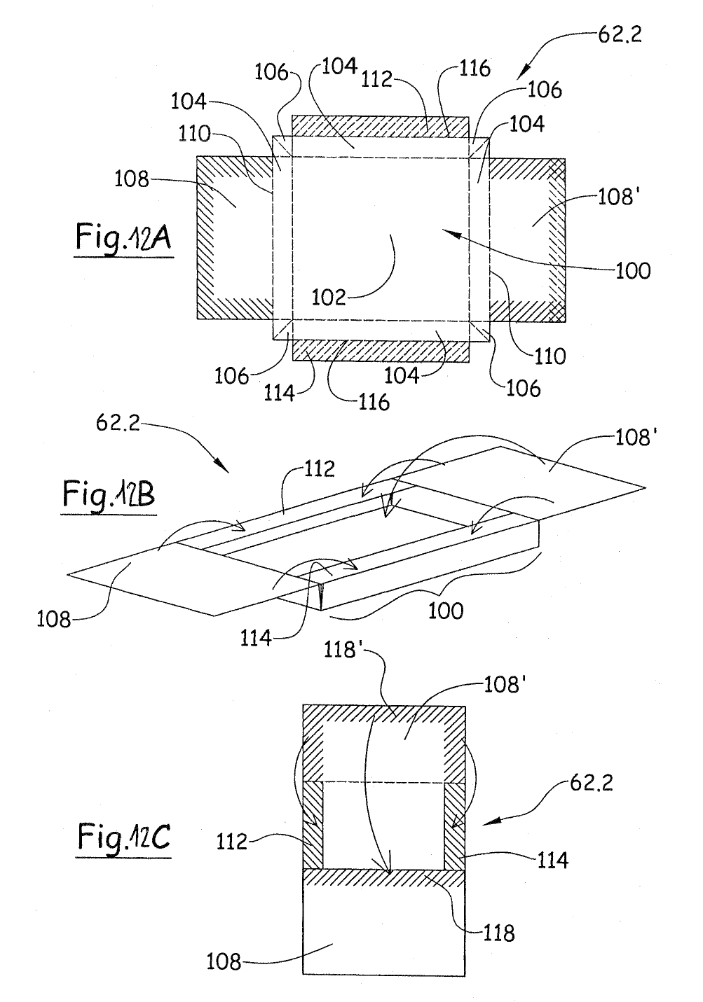

FIG. 2, a view of the mold making it possible to produce such a device,

FIG. 3, a view illustrating an embodiment of a mold that forms the tub,

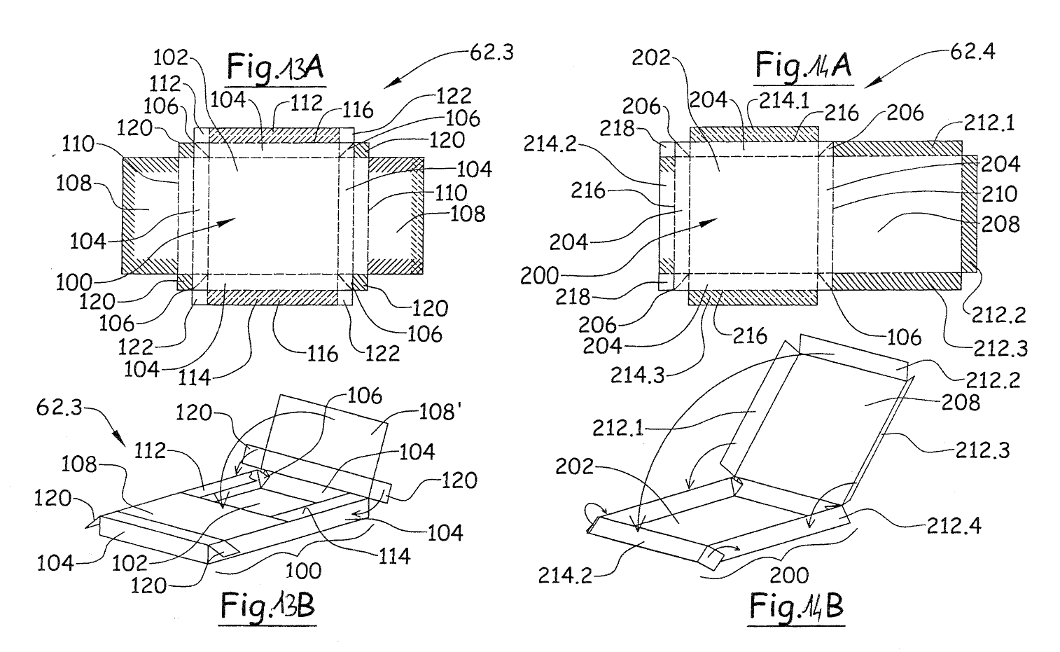

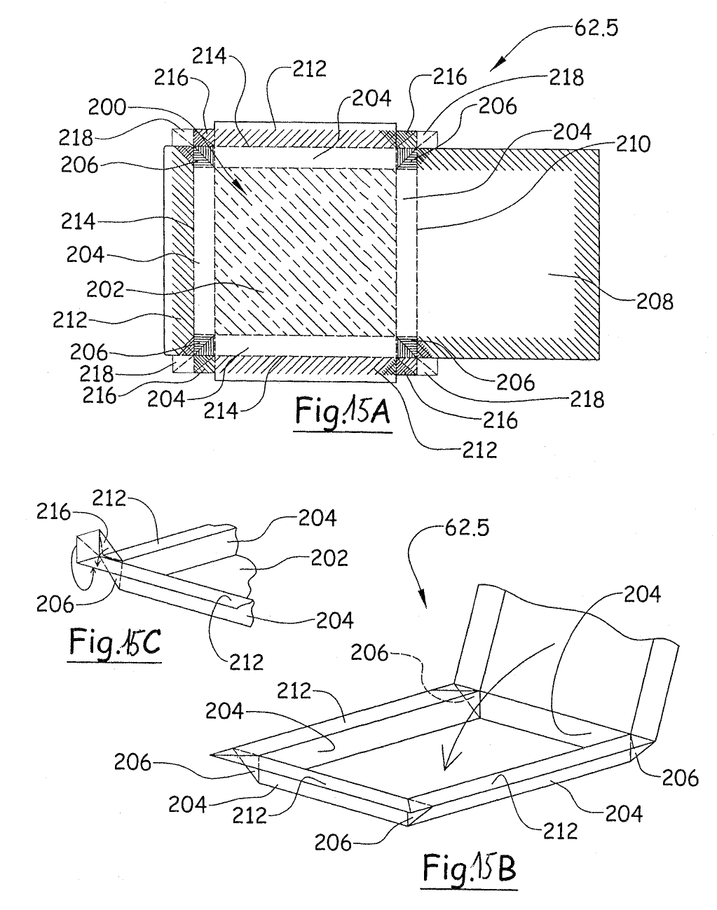

FIG. 4, a perspective view in detail of an angle of a tub,

FIG. 5, a view illustrating another embodiment of a mold,

FIG. 6A, a view that provides a flat illustration of a tub with a cover according to a first embodiment,

FIG. 6B, a section showing the tub of FIG. 6A that is formed,

FIG. 7A, a view that provides a flat illustration of a tub with a cover according to another embodiment that makes it easy to fill,

FIG. 7B, a top view that shows the tub of FIG. 7B in filling position, and

FIGS. 8A and 8B, sections of another method of packaging corn kernels before and after cooking,

FIG. 9A, a view of the device for display and cooking of kernels of corn according to this invention, in the folded position,

FIG. 9B, a view of this same device after unfolding, ready for cooking,

FIG. 10, a view of the mold making it possible to produce such a device,

FIG. 11A, a view of a mold illustrating a first embodiment of a small container,

FIG. 11B a perspective view of the small container of FIG. 11A during folding,

FIG. 11C, a side view illustrating the small container of FIG. 11A before filling,

FIG. 12A, a view of a mold illustrating a second embodiment of a small container,

FIG. 12B, a perspective view of the small container of FIG. 12A during folding,

FIG. 12C, a side view illustrating the small container of FIG. 12A before filling,

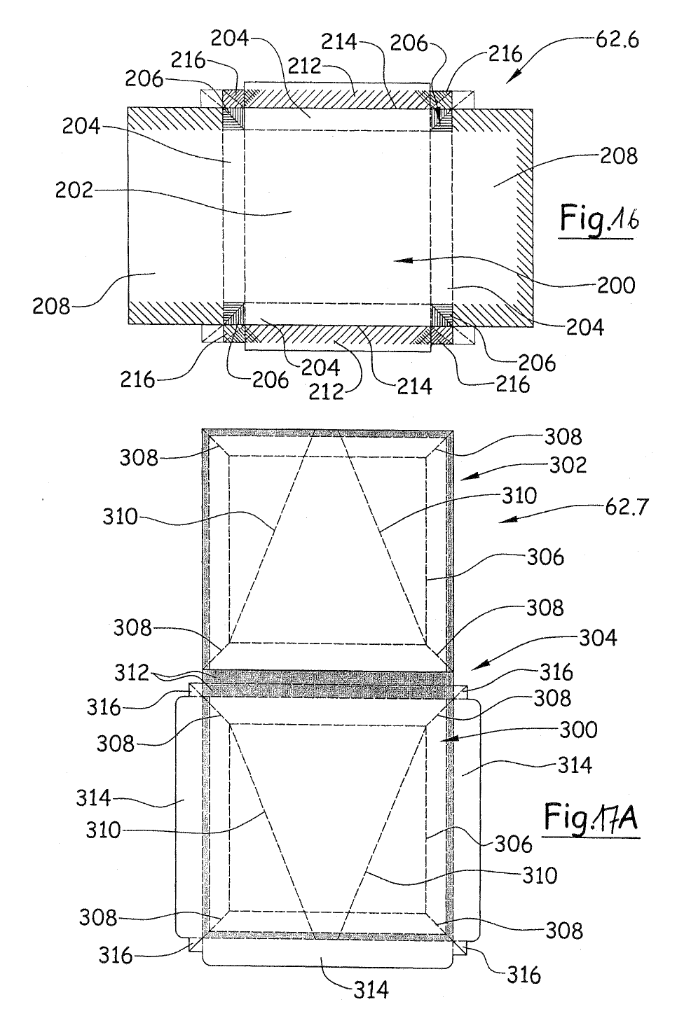

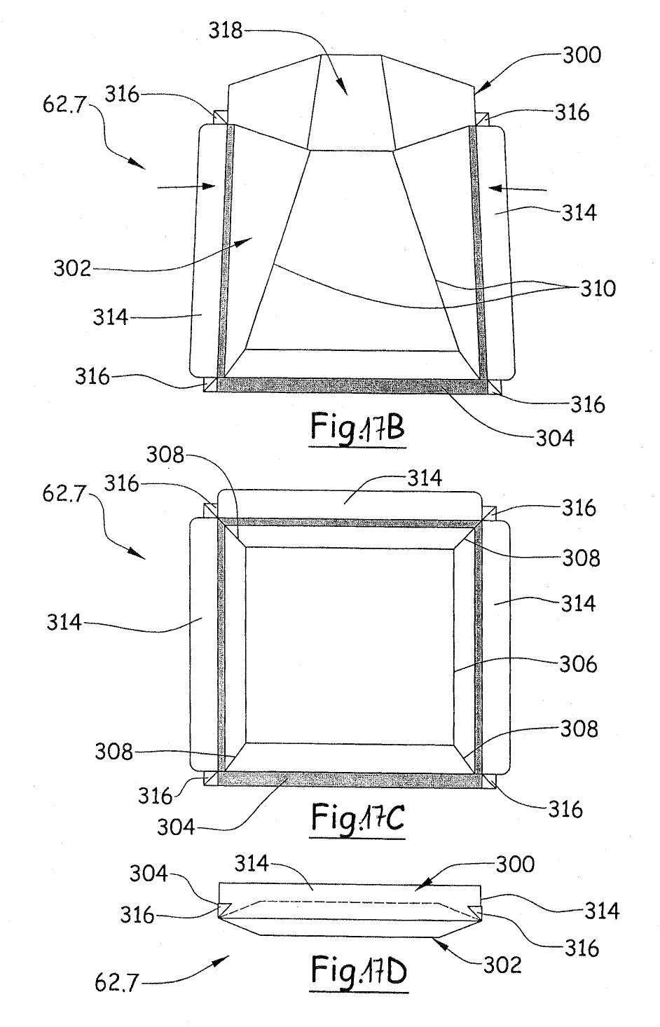

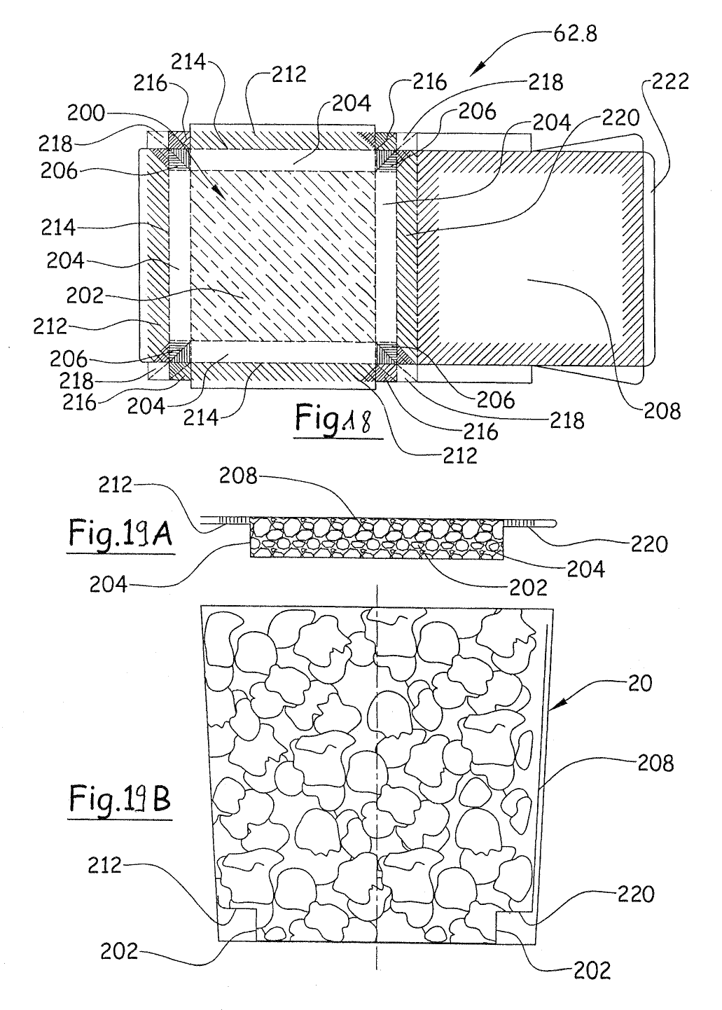

FIG. 13A, a view of a mold illustrating a third embodiment of a small container,

FIG. 13B, a perspective view illustrating the small container of FIG. 13A during folding,

FIG. 14A, a view of a mold illustrating a fourth embodiment of a small container,

FIG. 14B, a perspective view illustrating the small container of FIG. 14A during folding,

FIG. 15A, a view of a mold illustrating a fifth embodiment of a small container,

FIG. 15B, a perspective view illustrating the small container of FIG. 15A before filling,

FIG. 15C, a detail view illustrating in perspective an angle of the small container of FIG. 15B,

FIG. 16, a view of a mold illustrating a sixth embodiment of a container.

FIG. 17A, a view of a mold illustrating a seventh embodiment of a small container,

FIG. 17B, a perspective view illustrating the small container of FIG. 17A before filling,

FIG. 17C, a perspective view illustrating the small container of FIG. 17A after filling,

FIG. 17D, a side view of the small container of FIG. 17A that is ready to be used in a first container,

FIG. 18, a view of a mold illustrating an eighth embodiment of a small container,

FIG. 19A, a section illustrating the small container of FIG. 18 in closed position,

FIG. 19B, a section illustrating the small container of FIG. 18 in open position in a first container,

FIG. 20, a view of a mold illustrating a ninth embodiment of a small container,

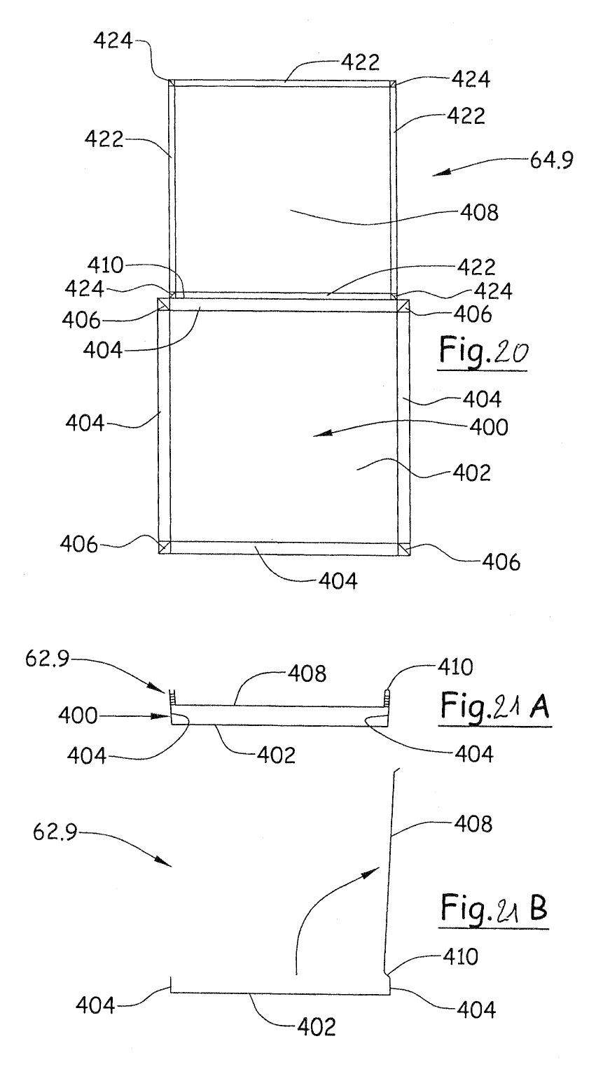

FIG. 21A, a section illustrating the small container of FIG. 20 in closed position, and

FIG. 21B, a section illustrating the small container of FIG. 20 in open position.

In FIG. 1A, the device 10 comprises a container 12 with a base 14, a compensating zone 16., unfolding means 18, and means 20 for opening/closing this container.

The unit is preferably made from a board-type material, more particularly a virgin-wood-fiber cardboard to preserve food quality.

The base is rectangular or square in shape and rigid and is on the order of 1 to 2 centimeters high to set forth the concept.

This base is intended to accommodate the raw corn kernels. The volume of kernels determines the amount of popcorn that will be produced. Nevertheless, it is understood that a small thickness is necessary because the microwave penetration capacity in food is low, on the order of 2 cm. It therefore is necessary to limit the base to this small height to obtain the greatest efficiency.

To increase the volume, it is suitable to vary the other dimensions.

The compensating zone is folded in FIG. 1A, but with an unfolding initiator so as to be able to distinguish the different parts. In reality, the height of the unit seems to be essentially the same as that of the height of the base.

This compensating zone comprises folds 22 and 24, respectively located on the faces opposite said retractable faces 26 and stiffening faces 28.

Retractable faces 26 each comprise a fold 30, obtained by grooving the board-type material, whereby this fold is approximately in the middle of each of the faces and parallel to the base.

Stiffening faces 28 each comprise several folds, a first fold 32 in the continuity of folds 330, placed in the median plane. In contrast, each fold 32 is also obtained by grooving, but comprises in the central portion a cutaway 34 that makes it possible to form a diamond-shaped window, with an opening that can vary during folding operations, as will be indicated below. Cutaway 34 is linear and optionally comprises additions to facilitate this opening. Advantageously, cutaway 34 can comprise at each end a cutaway 35 that extends in an approximately perpendicular manner to cutaway 34, on both sides of said cutaway 34 so as to prevent the box from tearing in the extension of cutaway 34.

In addition, 36 diagonal folds, also produced by grooving, are provided.

Thus obtained is a bellows with rigid, foldable walls.

Unfolding means 18 comprise two tabs 38, one per retractable face 26. As shown in FIG. 2, each tab is advantageously T-shaped. A slit 40 is located in each fold 30, whereby said slit has a length that allows the passage of the longitudinal branch 42 of the T and prevents the passage of transverse branch 44. In this embodiment that is presented, the assembly is simple and purely mechanical.

The transverse branch is optionally affixed directly to this retractable face 26, but on the outside.

The means 20 for opening/closing this container comprise two flaps 46, 48 that can be retracted and that are each provided with a clip 50, 52. Each clip can immobilize the opposite flap to ensure that flaps are locked in the closing position of the container.

The bottom of the container is formed, in a way known in box-making, by four flaps 54-60 being arranged alternately on top of one another.

To be certain that the corn kernels are well enclosed without the risk of passing through these flaps that are arranged alternately on top of one another, a tub 62, shown in FIG. 2, is provided.

This tub is also made of a material that absorbs the energy that is transported by the microwaves and that can generate infrared radiation that can trigger the Maillard reactions when these are kernels with sugars. In the case of corn kernels that are salted or buttered, no conversion occurs, but the energy that is absorbed improves the popping.

To preserve the corn kernels with the hygrometric degree necessary for popping thereof, generally on the order of 14%, it is necessary to place the device under a suitable complex film. This protective complex is opened at the time of use as for any other food product of this type.

The use of this device for the display and cooking of corn kernels to make popcorn thereof is now indicated.

The consumer withdraws from its package the device, which is in folded form with corn kernels immobilized in the base, in tub 62, if present. The base makes it possible to store the kernels and to immobilize them in a restricted space. The presence of the base also makes it possible to obtain a complete folding of compensating zone 16 contrary to the devices of the prior art. The consumer pulls on the two tabs 38 so as to remove the two retractable faces 26, at right angles with each fold 30, which has the effect of unfolding these two faces, removing base 14 from closing means 20 and simultaneously unfolding stiffening faces 28. The window 34 closes to no more than a slit, and these stiffening faces become essentially planar. The cutaway 34 that forms the window promotes the unfolding of the compensating zone 16 and reduces the deterioration of the edges connecting the faces 26 and 28. This cutaway 34 is even necessary when the faces 26 and 28 are trapezoidal to create a box shaped like an upside-down truncated pyramid.

The microwave oven is put into operation for the recommended period, which causes the popping of the corn kernels and the conversion of sugars.

The device is then filled with popcorn that is ready to eat.

The volume of the container is established based on the volume of kernels initially contained in the base.

The consumer can use tabs 38 to handle the device without being burned.

When he is ready the consumer opens two flaps 46, 48 by removing two clips 50, 52 to dig into the interior.

It is noted that the container is stable, rigid and makes it possible not only to store it before use in a compact form and to cook it, but also to display it, without it being necessary to tear or cut a bag with the concomitant risks of spilling the entire contents.

An additional significant advantage that solves the problem of residual heat is that the slits located in the different faces make possible an evacuation of the steam and prevent the concentration of this residual heat.

It is also noted that it is possible to reclose the two flaps 46 and 48 to preserve the remaining popcorn for the purpose of later consumption.

Such a device is industrially advantageous for its simple production.

Actually, the device according to the invention is completely rigid by itself.

The folding, the filling and the packaging of the device according to this invention can be easily automated.

Cardboard was mentioned because it is a particularly suitable material, but it would be possible to use a synthesis material, one of the conditions being to exhibit a certain rigidity.

Likewise, the presented shape has constant dimensions in height, but the container can be shaped like an upside-down truncated pyramid.

According to an improved version, the flaps 46 and 48 can be made detachable with pre-scoring to ensure that it opens fully and freely.

In FIGS. 3, 4, 5, 6A, 6B, 7A and 7B, various embodiments of tub 62 are shown.

According to a first embodiment, the tub is obtained from a quadrilateral-shaped mold 64 that preferably consists of a paper- or cardboard-based multilayer structure that is coated with at least one metalized sheet 66, indicated by dashes, which can absorb the energy that is transported by microwaves.

The mold 64 comprises four folding lines 68, each parallel to an edge of mold 64. delimiting flaps 70 that can form the lateral walls of the tub. Folding lines 68 delimit in the center the bottom of the tub whose dimensions are adapted to the base 14.

At the level of each angle, a folding line 72 is provided that connects each angle of the mold and the corresponding point of intersection of the folding lines 68 to allow the folding of the lateral walls of the tub. Preferably, excess thickness zones 74, produced by the folding of lateral walls at each angle, are retracted against the outside faces of said lateral walls, as illustrated in detail in FIG. 4, so as to form a trough that flows in the direction of the inside of tub 62 to limit the leakage of grease outside of said tub 62.

Preferably, as illustrated in FIG. 3, the metalized sheet 66 is placed between two parallel folding lines 68 to keep metalized zones from coming into contact at corners and to limit heating risks.

According to another characteristic of the invention, as illustrated by FIG. 5, the flaps 70 that form the lateral walls of the tub each comprise an extension 76 that can cover a portion or the entirety of the inside walls of the box 10 so as to reduce the risks of contact of the grease with the walls of said box 10.

According to another characteristic, the tub comprises an clement that forms a cover to isolate the food products, either in the form of a film or in the form of a covering sheet 78 that is made of cardboard or a semi-rigid material and that is connected to the lateral walls of the small container 62 with a seam or glue that is preferably thermosetting, as illustrated in FIGS. 6A, 6B, 7A and 7B.

Advantageously, covering sheet 78 is cross-shaped and comprises offsets 80 so as not to cover the angle zones of the mold 64 and to prevent excess thicknesses in this folding zone. The sheet 78 preferably comprises first folding lines 82 that are parallel to the folding lines 68, slightly offset toward the outside to facilitate the shaping of the tub 62.

The covering sheet 78 advantageously comprises second folding lines that make it possible to obtain a volume that can contain food products, as illustrated in FIG. 6B. The second folding lines make it possible to obtain a truncated pyramid shape and comprise folding lines that delimit a square 84 and diagonal folding lines 86 connecting each peak of said square to the angle of the corresponding offset 80.

According to another characteristic of the invention, illustrated by FIGS. 7A and 7B, the covering sheet 78 comprises third folding lines 88, not parallel to the first folding lines 82, forming a truncated triangle with one of the sides of the square 84. When the opposing sides of the tub 62 are pulled together, these folding lines 88 make it possible to create a pour funnel as illustrated in FIG. 7B.

Of course, the embodiment of FIGS. 6A and 6B can comprise extensions 76 as illustrated in FIG. 5 and/or a metalized sheet 66 as illustrated in FIG. 3.

In FIGS. 8A and 8B, another method for packaging food products was shown. This packaging method comprises a packet 90 that rests on a sheet 92, made of a material that is identical to that of mold 64, covering the bottom of the box. The packet 90 comprises seam lines, one 94 oriented upward, which are thermosetting at the temperature at which popcorn is cooked, so that they open during cooking and flatten against the inside walls of the box to reduce the risk of the walls of said box 10 coming into contact with the grease, as illustrated in FIG. 813.

In FIGS. 9A, 9B and 10, another variant of the first container 12 is shown. The elements that are identical to the preceding variant are referenced in the same manner.

According to this variant, the means 20 for opening/closing comprise two flaps 46, 48 that can be retracted, one 48 of them comprising a tab 96 that can pass through a slit 98 that is located on the other flap 46. On its free end, the tab 96 comprises a retracted edge 99. According to an embodiment, the tab 96 is obtained using two cut-outs that extend over an adequate length from the free edge of the flap 48 that is opposite to the edge that is connected to the compensation zone 16. In addition, the slit 98 has suitable dimensions for allowing the tab to pass and is positioned close to the free edge of the flap 46 that is opposite to the edge that is connected to the compensation zone.

The operation of the means 20 for opening and for closing is as follows:

In the closed position, the tab 96 passes through the slit 98. During cooking, the volume of popcorn gradually increases until the flaps 46 and 48 are slightly raised. This movement is allowed and controlled by the tab 96 that slides into the slit 98 until the retracted edge 99 reaches—and is immobilized at—the slit 98. This slight raising of the flaps makes it possible to indicate the end of the cooking, which facilitates the use of the device of the invention.

It is possible to adjust the rising height based on, in particular, the length of the tab.

To be certain that the kernels of corn are stored well without the risk of passing through these flaps that are arranged alternately on top of one another and for packaging hermetically the kernels of corn and the optional other ingredients, a small container 62 that constitutes a second container that is placed at the base of the first container described above is provided. In the various FIGS. 11A to 21B, various embodiments of said small container are shown.

The small container 62 is produced from a mold that is cut out in a complex that comprises at least two sheets placed side by side, one made of rigid paper or cardboard, the other made of plastic, ensuring the sealing, such as, for example, polyethylene.

Advantageously, the complex comprises, at the level of at least one zone, a layer made of a material that absorbs the electromagnetic waves called a susceptor.

According to the invention, the small container 62 is made from a mold that comprises a first portion that forms a container that can accommodate the kernels of corn and the possible other ingredients and at least a second portion that forms a pivoting cover that is connected to the first portion, on the one hand, by at least one folding line that forms a joint, and, on the other hand, by a thermosetting bond so as to form a sealed chamber in a first state called a closed state and to allow the pivoting of the cover so as to allow the expansion of the popcorn in a second state called an open state, after the thermosetting bond is broken when the temperature exceeds a certain threshold.

This arrangement makes it possible to obtain a sealed chamber that ensures a better preservation of the products. Furthermore, the fact of providing at least one pivoting cover that is always connected to the container and that is flattened against the walls of the compensation zone 16 in the open state makes it possible to increase the safety, whereby the user no longer has to remove a hot element such as a film. Finally, this arrangement makes it possible to obtain a more appetizing product, no element to be removed being mixed with the popcorn any longer in the manner of a film of the prior art.

Preferably, the small container 62 is placed in the first container so that said pivoting cover is flattened against one of the stiffening faces 28.

The cover optionally can be detached from the remainder of the small container 62 using a precut line.

In FIGS. 11A, 11B and 11C, a first embodiment of a small container 62.1 is shown.

In this case, the referenced container 100 comprises a square or rectangular bottom 102 and four lateral walls 104 that are connected to the four sides of the bottom 102 via folding lines, whereby the lateral walls 104 are connected two by two by bellows 106 that participate in the scaling of the small container.

The small container 62.1 comprises two pivoting covers 108, 108′ that are connected by folding lines 110 to opposite lateral walls 104.

Each pivoting cover 108, 108′ comprises a first flap 112 at a first lateral edge and a second flap 114 at a second edge (opposite to the first edge), whereby the flaps are hinged relative to the remainder of the cover using folding lines 116.

To form the small container, in a first step the container is produced by folding the lateral walls 104 and the bellows 106 as illustrated in FIG. 11B. Then, as illustrated in this same figure, a first cover 108 is retracted in closed position, whereby the flaps 12 and 114 are bonded—using a thermosetting bond—to the outside surfaces of the lateral walls 104 to obtain a container as illustrated in FIG. 11C.

Next, the container is filled in a vertical position. After filling, the second pivoting cover 108′ is retracted in closed position, whereby the flaps 112 and 114 are bonded using a thermosetting bond on the outside surfaces of the lateral walls 104. To obtain a sealed bond between the covers, the inside surface of the free edge 118′ of the cover 108′ is linked—using a thermosetting bond—to the outside surface of the free edge 118 of the cover 108.

FIGS. 12A to 12C illustrate a second embodiment of a small container 62.2.

In this case, relative to the first embodiment, the flaps are borne by the lateral walls of the container.

There is a container 100 with a bottom 102, lateral walls 104 and bellows 106. The small container 62.2 also comprises two covers 108 and 108′ that are connected by folding lines 10 to opposite lateral walls 104.

The lateral walls 104 that do not bear the covers are extended by the flaps 112 and 114 that are hinged relative to the lateral walls using folding lines 116.

As above, this embodiment allows filling in vertical position.

Furthermore, to ensure the sealing, the inside surface of the free edge 118′ of the cover 108′ is linked using a thermosetting bond to the outside surface of the free edge 118 of the cover 108.

The first two embodiments may each have a variant in which the small container comprises only a single cover that covers the entire container, connected to a single lateral wall, whereby the flaps are provided on the three free edges of the cover or at the level of the three lateral walls that do not bear the cover.

FIGS. 13A and 13B illustrate a third embodiment of a small container 62.3 that is very close to the second embodiment. The identical elements are referenced in the same manner.

In addition to the second embodiment, in this case, a first series of folds 120 are connected to the covers 108 and 108′ at each angle that is formed by the covers and the bellows. Once the cover is retracted, these folds are bonded using a thermosetting bond against the outside surface of the lateral walls. In addition or as substitution, a second series of folds is connected to the flaps 112 and 114 at each angle formed by the flaps and the bellows, whereby said folds 122 are placed between the bellows and the lateral walls.

These series of folds 120 and 122 contribute to improving the sealing at the upper angles of the small container.

In FIGS. 14A, 14B, 15A, 15B, 15C, 16, 17A, 17B, 17C, 17D, 18, 19A and 19B, 20, 21A and 21B, variants are shown that have the advantage of bonding the coated surfaces with the same material, namely bonding the surfaces that are coated by plastic with the surfaces that are coated by plastic.

This solution contributes to simplifying the bonding or the welding and increases significantly the sealing that is reflected by a longer preservation period.

Thus, in FIGS. 14A and 14B, a fourth embodiment of a small container 62.4 is shown.

This small container comprises a container 200 with a square or rectangular bottom 202 and four lateral walls 204 that are connected to the four sides of the bottom 202 via folding lines, whereby the lateral walls 204 are connected two by two by bellows 206 that participate in the sealing of the small container.

It also comprises a pivoting cover 208 that is connected by a folding line 210 to one of the lateral walls 204.

At its free edges, this pivoting cover 208 comprises flaps 212.1, 212.2 and 212.3 that are able to work respectively with flaps 214.1, 214.2, and 214.3 that are connected by the folding lines 216 to the lateral walls. The flaps are connected two by two by a thermosetting bond to allow the opening of the small container during the cooking.

Advantageously, the flap 214.2 that is used at the lateral wall opposite to the one that supports the cover comprises folds 218 on each side, and said folds can be bonded against the adjacent flaps 214.1 and 214.2. In the other FIGS. 15A, 15B, 15C, 16, 17A, 17B, 17C, 17D, 18, 19A and 19B, variants are shown whose advantage is to provide surfaces for bonding or welding the cover in the same plane and one or more flat cover(s) that make it possible to simplify this operation and to increase the quality of the sealing that is thus obtained.

In FIGS. 15A, 15B and 15C, a fifth embodiment of a small container 62.5 is shown.

There is a container 200 with a bottom 202, lateral walls 204 and bellows 206. Contrary to the preceding embodiments, the bellows are folded toward the outside of the container.

This small container also comprises a cover 208 that is connected via a folding line 210 to one of the lateral walls 204 and optionally to the bellows 206 that are adjacent to said wall 204. The cover has a width that extends beyond the lateral wall, essentially equally to that of the lateral wall and two adjacent bellows.

In addition, the small container 62.5 comprises flaps 212 that are connected by a folding line 214 to the lateral walls that are not connected to the cover 208 and that are not retracted against the outside surface of the lateral walls as for the fourth embodiment but folded essentially 90° relative to said lateral walls toward the outside and are placed in the same plane that is essentially parallel to the bottom 202. To facilitate the shaping of the container 200 and flaps 212, bellows 216 are provided that each have a common side with a first bellows 206 and a flap 212.

As illustrated in FIG. 15C, these bellows 216 are formed above flaps 212 then retracted on the flaps so as to connect the flaps 212 to one another.

The use of this small container is as follows:

In a first step, the container 200 is formed by bonding or welding the bellows 206. This welding or bonding is preferably resistant to heat and is not thermosetting. Following this operation, the lateral walls are straightened. Next, the flaps 212 are folded 90°, and the bellows are formed, as illustrated in FIG. 15C. They are then retracted and bonded or welded onto the flaps 212. As above, this welding or bonding is preferably heat-resistant and is not thermosetting.

After filling the container, operated horizontally, the cover is closed by bonding it or by welding it in a thermosetting manner against the flaps 212.

According to this embodiment, it is noted that the flaps 212 participate in the wedging of the small container 62.5 in the first container. As indicated above, the small container is positioned in the first container so that the cover is flattened against a stiffening face 26 in open position. Advantageously, the flaps 212 that are placed against the retractable surfaces 28 have suitable shapes and are in particular broader to immobilize the small container well and to follow the shapes of said surfaces 28 that have a tendency to curve toward the outside.

According to an improvement, it is possible to provide, at the level of the angles, a third bellows 218 that is formed and folded under the flaps 212. This flap makes it possible to reduce the risks of leakage.

In FIG. 16, a sixth embodiment of a small container 62.6 that is very close to the fifth embodiment comprising two covers 208 is shown. The elements that are identical to the fifth embodiment bear the same references.

In FIGS. 17A to 17D, a seventh embodiment that allows a filling in vertical position of a small container 62.7 is shown.

This small container 62.7 has a container 300 and a cover 302 that are connected to one another by a junction zone 304 that comprises the pivoting axis of the cover relative to the container.

The container 300 and the cover 302 have symmetrical shapes relative to the junction zone 304.

Thus, each of them has a square or rectangular shape, with a first centered square or rectangular folding line 306, and second folding lines 308 that connect the tips of the first folding line 306 to the angles of the cover or the container. These folding lines make it possible to obtain a truncated pyramid.

Two third folding lines 310 are provided, symmetrical relative to the median axis that is perpendicular to the pivoting axis of the cover, whereby said lines extend from the tips of the first folding line 306 that is close to the junction zone and tends to join it.

In addition, the edges of the container that are not connected to the junction zone 304 are welded or bonded to the corresponding edges of the cover using a thermosetting bond that can be broken during cooking.

According to an embodiment, the junction zone 304 can be limited to a folding line or, as illustrated in the figures, to two first contiguous flaps 312 that are bonded or welded against one another, whereby preferably this bond is not thermosetting.

To ensure better stability, the small container 62.7 comprises—at the level of the edges of the container—second flaps 314 that are connected between one another or to one of the first flaps 312 by bellows 316. These flaps are folded 90° and are kept in this position using bellows 316 that are formed and bonded or welded against the outside surface of the flaps as illustrated in FIG. 17D.

This embodiment is used in the following manner:

In a first step, the flaps 312 are bonded one against the other, then two opposite edges of the container and the cover are bonded or welded.

To fill the small container, the junction zone is placed downward and the edges of the container and the cover that is not bonded or welded are oriented upward. By pushing the edges that are opposite and that are bonded with the container and the cover toward one another, as illustrated in FIG. 17B, an opening 318 is produced. The third folding lines 310 contribute to the formation of this opening that promotes the filling in vertical position.

After filling, the third edges of the container and the cover are bonded or welded so as to obtain a small sealed container as illustrated in FIG. 17C. The folding lines 306 and 308 make it possible to obtain a volumetric form.

Then, the flaps 312 and 314 are folded 90°, and the bellows 316 are bonded or welded so as to keep them in this folded position, as illustrated in FIG. 17D.

This embodiment makes it possible to obtain a vertical filling to simplify the welding or bonding phase of the container and the cover.

In FIGS. 18, 19A and 19B, an eighth embodiment that makes possible filling in horizontal position of a small container 62.8 is shown.

This small container is close to the embodiment that is illustrated in 15A, 15B, and 15C, whereby the identical elements are referenced in the same manner.

According to this embodiment, the cover 208 is bonded to the container along its entire perimeter. Thus, the four sides of the cover are bonded against the flaps 212 and a flap 220 that is inserted between a lateral wall 204 and the cover 208. This solution makes it possible to obtain essentially the same resistance to the opening for the entire perimeter of the cover.

According to another improvement, at the side opposite to that from which said cover 208 is connected to the remainder of the small container, the cover 208 comprises a projecting portion 222 that may or may not extend over the entire length of said side so as to keep the cover 208 in closed position and to slow down its opening so as to obtain a sudden and quick complete opening. This configuration makes it possible to limit the risk of seeing popcorn be placed between the cover 208 and the wall of the first container so as to prevent the complete opening of said cover, which could cause overcooking of some kernels.

In FIG. 19A, the small container is shown in closed position. It is noted that the side of the cover 208, close to its joint with the remainder of the small container, is also bonded.

In FIG. 19B, the small container is shown in open position in a first container. It is noted that the cover is flattened against one of the walls of said first container with dimensions suitable to said container in particular in height so that the free end of the cover is close to the upper portion of the first container to limit the risk of seeing a popcorn kernel interposed between the cover and the lateral wall of said first container.

In this context, the small containers that comprise a single cover are preferred relative to those that comprise two covers because said covers are higher, which limits the risk of seeing a popcorn kernel jump above said cover and become interposed between said cover and the lateral wall of the first container.

The cover 208 can comprise folds at the lateral edges. Advantageously, these folds are made of two independent portions, whose shapes are adapted to the first container to limit the risk of seeing a popcorn kernel become interposed between said cover and the lateral wall of the first container. According to another improvement, the flaps 212 are broadened to rise along the lateral walls of the first container, as illustrated in FIG. 19B.

In FIGS. 20, 21A and 21B, a ninth embodiment that allows a filling in vertical position of a small container 62.9 is shown.

This small container comprises a container 400 with a square or rectangular bottom 402, and four lateral walls 404 connected to the four sides of the bottom 402 by folding lines, whereby the lateral walls 404 are connected two by two by bellows 406 that participate in the sealing of the small container.

When the lateral walls 404 are placed vertically, the bellows 406 are formed outside the container then retracted on the outside surface of the walls so as to keep them perpendicular to the bottom 402.

This small container also comprises a cover 408 that is connected via a folding line 410 to one of the lateral walls 404.

According to this embodiment, the cover 408 comprises a central portion 420 whose dimensions are essentially identical to those of the bottom 402 and four flaps 422, one at the level of each side, each being able to work with a lateral wall 404. Advantageously, the flaps 422 are connected two by two at angles via bellows 424. According to this embodiment, the flaps 422 are bonded at the upper edge of the lateral walls 404 so that said flaps are folded 90° and oriented upward relative to the central portion 420, whereby the latter is offset downward relative to the upper end of the lateral walls 404.

In closed position, the bellows 424 are clamped between the two portions of the bellows 406 to ensure good sealing.

In practice, the cover 408 is closed on three sides, whereby only the flap 422 that is opposite to the junction line 410 is not bonded. The filling of the small container is carried out in vertical position. At the end of the filling, the last flap 422 is bonded to the corresponding lateral wall 404.

To bond or weld the elements, it is possible to use a related element such as a glue that may or may not be thermosetting according to the requirements, or any related element, whereby the plastic surfaces of the complex that is used to form the small container are heated then flattened against one another in the connecting zones.

To obtain a definitive welding or a thermosetting welding that breaks during cooking, the rise in temperature is adjusted during the welding. By way of example, for a complex with a PET or polyethylene terephthalate surface, an elevation that is greater than or equal to approximately 270° C. is achieved to obtain a non-reversible welding and a temperature rise on the order of 180° C. to obtain a reversible welding and to obtain a thermosetting bond.

Regarding the complex, the latter comprises a layer made of material that absorbs the electromagnetic waves at the bottom of the small container alone.

1. Device for packaging and cooking that is suitable for popcorn and that comprises a first container into which is placed a small container (62) of limited volume, characterized in that the small container (62) is produced from a mold that comprises a first portion that forms a container (100, 200, 300, 400) and at least a second portion that forms a pivoting cover (108, 208, 302, 408) that is connected to the first portion, on the one hand, by at least one folding line that forms a joint, and, on the other hand, by a thermosetting bond so as to form a sealed chamber in a first state called a closed state and to allow the pivoting of the cover so as to allow the expansion of popcorn into a second state called an open state, after the thermosetting bond is broken when the temperature exceeds a certain threshold.

2. Device for packaging and cooking according to claim 1, wherein the container and/or the cover comprises flaps that are linked to the container and/or to the cover or to other laps by a thermosetting bond.

3. Device for packaging and cooking according to claim 2, wherein the container (100, 200, 400) comprises a square or rectangular bottom (102, 202, 402), and four lateral walls (104, 204, 404) that are connected to one another by bellows (106, 206, 406).

4. Device for packaging and cooking according to claim 3, wherein said at least one cover (208) is flat and wherein the container comprises flaps (212) that are placed in the same plane against which said at least one cover is flattened.

5. Device for packaging and cooking according to claim 4, wherein the flaps (212) are folded 90° relative to the lateral walls toward the outside of the container.

6. Device for packaging and cooking according to claim 5, wherein the flaps (212) are connected via bellows (216).

7. Device for packaging and cooking according to claim 1, wherein the container (300) and the cover (302) are connected by a junction zone (304) and have symmetrical shapes relative to said junction zone (304).

8. Device for packaging and cooking according to claim 7, wherein the cover (300) and the cover (302) each have a square or rectangular shape, a first centered square or rectangular folding line (306), and second folding lines (308) connecting the tips of the first folding line (306) with the angles of the cover or the container.

9. Device for packaging and cooking according to claim 8, wherein the edges of the container and the cover are connected by a thermosetting bond.

10. Device for packaging and cooking according to claim 1, wherein the small container is produced from a mold that is cut out in a complex that comprises at least two sheets placed side by side, one made of rigid paper or cardboard, the other made of plastic, ensuring the sealing.
